(19) United States
(12) Patent Application Publication
(10) Pub. No.: US 2024/0004152 A1
(43) Pub. Date: Jan. 4, 2024

(54) FEW MODE OPTICAL FIBERS WITH REDUCED MODE COUPLING AND LOW BIREFRINGENCE

(71) Applicant: CORNING INCORPORATED, CORNING, NY (US)

(72) Inventors: Xin Chen, Painted Post, NY (US); Kangmei Li, San Jose, CA (US); Ming-Jun Li, Horseheads, NY (US)

(21) Appl. No.: 18/212,315

(22) Filed: Jun. 21, 2023

Related U.S. Application Data
(60) Provisional application No. 63/357,079, filed on Jun. 30, 2022.

(51) Int. Cl. G02B 6/44

(52) U.S. Cl. CPC G02B 6/4429

(57) ABSTRACT

A few mode optical fiber that includes a core and a cladding surrounding the core, the cladding comprising at least one stress member. The core and the cladding support the propagation and transmission of at least LP01, LP11a, and LP11b modes at one or more wavelengths. Furthermore, the LP01, LP11a, and LP11b modes each have a birefringence of about 5.7×10⁻⁶ or less at 1310 nm. And an effective index difference between the LP11a and LP11b modes is about 3.0×10⁻⁵ or greater.

This application claims the benefit of priority under 35 U.S.C § 120 of U.S. Provisional Application Ser. No. 63/357,079 filed on Jun. 30, 2022, the content of which is relied upon and incorporated herein by reference in its entirety.

### FIELD

The present specification generally relates to optical fibers and, more specifically, to few mode optical fibers with reduced mode coupling and low birefringence used for mode division multiplexing.

### BACKGROUND

The explosive growth in the volume and variety of multi-media telecommunication applications continues to drive speed demands for internet traffic and motivate research in backbone fiber-optic communication links. The use of few mode or multimode optical fibers provides higher information capacity, as compared to single mode fibers, through a mode division multiplexing technique. Mode division multiplexing is a technique to increase the data capacity of a fiber by using different guided modes for different transmission channels. Each mode can be used to transmit independent optical channels along the fiber.

However, few mode and multimode fibers often suffer from distortion issues, which become even more prevalent over longer fiber distances. For example, two or more modes in the fiber may experience mode coupling in which a light pulse launched into a first mode couples with a second mode. Such mode coupling leads to a superposition of pulses at the fiber output, causing interference of the pulses and a reduction of fiber bandwidth.

Accordingly, a need exists for alternative designs of few mode optical fibers with reduced mode coupling while still providing an efficient fiber system that provides good transmission quality.

### SUMMARY

Embodiments of the present disclosure provide few mode optical fibers with reduced mode coupling, which may be used for mode division multiplexing systems. More specifically, the embodiments of the present disclosure provide few mode optical fibers with reduced mode coupling without sacrificing transmission quality of the fibers. The optical fibers disclosed herein have a high effective index difference between the guided modes in order to reduce crosstalk and, thus, reduce mode coupling of the guided modes. Furthermore, the optical fibers disclosed herein have low birefringence in order to provide good transmission quality over long fiber distances.

An aspect of the disclosure is a few mode optical fiber comprising a core and a cladding surrounding the core, the cladding comprising at least one stress member. The core and the cladding support the propagation and transmission of at least LP01, LP11a, and LP11b modes at one or more wavelengths. Furthermore, the LP01, LP11a, and LP11b modes each have a birefringence of about 5.7×10⁻⁶ or less at 1310 nm. And an effective index difference between the LP11a and LP11b modes is about 3.0×10⁻⁵ or greater.

Another aspect of the disclosure is a few mode optical fiber comprising a core and a cladding surrounding the core, the cladding comprising at least one stress member. The core and the cladding support the propagation and transmission of at least LP01, LP11a, and LP11b modes at one or more wavelengths. Furthermore, at least one of the LP01, LP11a, and LP11b modes has a birefringence of about 1.0×10⁻⁶ or less at 1310 nm.

Additional features and advantages of the disclosure are set forth in the detailed description that follows, and in part will be readily apparent to those skilled in the art from that description or recognized by practicing the embodiments described herein, including the detailed description that follows, the claims, as well as the appended drawings. The claims are incorporated into and constitute part of the Detailed Description as set forth below.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a side view of a section of a few mode optical fiber, according to embodiments disclosed herein;

FIG. 2A is a cross-sectional view taken along line A-A of the few mode fiber of FIG. 1, according to embodiments disclosed herein;

FIG. 2B shows an enlarged view of the core of FIG. 2A, according to embodiments disclosed herein;

FIG. 3 shows an enlarged view of a portion of the cross-sectional view of FIG. 2A, according to embodiments disclosed herein;

FIG. 4 shows another cross-sectional view of the few mode fiber of FIG. 1, according to embodiments disclosed herein; and

FIG. 5 shows another cross-sectional view of the few mode fiber of FIG. 1, according to embodiments disclosed herein.

### DETAILED DESCRIPTION

Reference will now be made in detail to embodiments of optical fibers for use as long haul transmission fibers, examples of which are illustrated in the accompanying drawings. Whenever possible, the same reference numerals are used throughout the drawings to refer to the same or like parts.

The following terminology will be used herein to describe the optical fibers, with some of the parameters being introduced and defined below in connection with the various exemplary embodiments:

“Refractive index” refers to the refractive index at a wavelength of 1550 nm, unless otherwise specified.

The term “relative refractive index,” as used herein, is defined as:

Δ(r)%=100×[n(r)²−n_{REF}²)]/2n(r)²,

where n(r) is the refractive index at radius r, unless otherwise specified. The relative refractive index is defined at 1550 nm unless otherwise specified. In one aspect, the reference index n_{REF} is silica glass. In another aspect, n_{REF} is the maximum refractive index of the cladding. As used herein, the relative refractive index is represented by Δ and its values are given in units of “%”, unless otherwise specified. In cases where the refractive index of a region is less than the reference index n_{REF}, the relative refractive index is negative and is referred to as having a depressed region or depressed-index region or trench region, and the minimum relative refractive index is calculated at the point at which the relative index is most negative unless otherwise specified. In cases where the refractive index of a region is greater than the reference index n_{REF}, the relative refractive index is positive and the region can be said to be raised or to have a positive index.

The “effective index,” as used herein, is the same as the refractive index of an optical fiber with the assumption that the core and the cladding of the optical fiber act as one equivalent material rather than two different materials. The effective index is provided by the following equation:

v=c/n_{eff}

where v is the speed of light for each mode in an optical fiber having a core and cladding, c is the speed of light in a vacuum, and n_{eff} is the effective index. With this definition of effective index, a light traveling through an optical fiber with a core having a refractive index of n_{core} and a cladding having a refractive index of n_{clad} is equivalent to light traveling through a uniform medium with a refractive index n_{eff}. To determine the effective index, both the refractive index profile of the core and of the cladding need to be taken in account through numerical modeling of the Maxwell equations, which are described in more detail in “Fundamentals of Optical Waveguides” by Katsunari Okamoto, 2^{nd} Edition (2006).

The term “updopant,” as used herein, refers to a dopant which raises the refractive index of glass relative to pure, undoped SiO₂. The term “downdopant,” as used herein, is a dopant which has a propensity to lower the refractive index of glass relative to pure, undoped SiO₂. An updopant may be present in a region of an optical fiber having a negative relative refractive index when accompanied by one or more other dopants which are not updopants. Likewise, one or more other dopants which are not updopants may be present in a region of an optical fiber having a positive relative refractive index. A downdopant may be present in a region of an optical fiber having a positive relative refractive index when accompanied by one or more other dopants which are not downdopants. Likewise, one or more other dopants that are not downdopants may be present in a region of an optical fiber having a negative relative refractive index.

As used herein, the “effective area” A_{eff} of an optical fiber is the area of the optical fiber in which light is propagated and is defined as:

$$\\ {A}_{eff} = 2 π \frac{{( {\int }_{0}^{∞} {E}^{2} rdr )}^{2}}{{\int }_{0}^{∞} {E}^{4} rdr} ,$$

where E is the electric field associated with light propagated in the fiber and r is the radius of the fiber. The effective area A_{eff} is determined at a wavelength of 1550 nm, unless otherwise specified.

As used herein, the term “few mode fiber” refers to a fiber supporting the propagation of more modes than a single mode fiber but fewer modes than a normal multimode fiber. The number of propagating modes and their characteristics in a cylindrically symmetric optical fiber with an arbitrary refractive index profile is obtained by solving the scalar wave equation (see for example T. A. Lenahan, “Calculation of modes in an optical fiber using a finite element method and EISPACK,” Bell Syst. Tech. J., vol. 62, no. 1, p. 2663, February 1983). Light travelling in an optical fiber or other dielectric waveguide forms hybrid-type modes, which are usually referred to as LP (linear polarization) modes. The LP0p modes have two polarization degrees of freedom and are two-fold degenerate, the LP1p modes are four-fold degenerate and the LPmp modes with m>1 are four-fold degenerate. We do not count these degeneracies when we designate the number of LP modes propagating in the fiber. For example, an optical fiber in which only the LP01 mode propagates is a single-mode fiber, even though the LP01 mode has two possible polarizations. A few-moded optical fiber in which the LP01 and LP11 modes propagate supports three spatial modes since the LP11 mode is two-fold degenerate, and each mode also has two possible polarizations, giving a total of 6 modes. Thus, when a fiber is said to have two LP modes, it is meant that it supports the propagation of all of the LP01 modes and LP11 modes.

The term “modal delay,” as used herein, refers to the time delay of a mode over a given fiber length and can also be referred to as group delay or time of flight.

The term “α-profile” or “alpha profile,” as used herein, refers to a relative refractive index profile, expressed in terms of Δ which is in units of “%”, where r is the radius and which follows the equation:

$$\\ Δ = {Δ}_{0} [ 1 - {( \frac{r}{{r}_{0}} )}^{α} ] ,$$

where Δ₀ is the maximum relative refractive index, r₀ is the radius of the core, r is in the range rᵢ≤r≤r_{f}, Δ is as defined above, rᵢ is the initial point of the α-profile, r_{f} is the final point of the α-profile, and α is a real number exponent. For a step index profile, the alpha value is greater than or equal to 10. For a graded index profile, the alpha value is less than 10. The term “parabolic,” as used herein, includes substantially parabolically shaped refractive index profiles with α=2 as well as profiles in which the curvature of the core varies slightly from α=2 at one or more points in the core, e.g., profiles having a centerline dip. It is noted here that different forms for the core radius and maximum relative refractive index are used in the examples below without affecting the fundamental definition of delta (Δ).

The term “birefringence,” as used herein, refers to the effective index difference between orthogonal (i.e., x and y) polarization states of a mode propagating in the core portion of an optical fiber. It is the phenomenon by which an incident ray of light is split into two rays. Birefringence may be observed in an optical fiber due to asymmetry in the fiber along its core and/or due to external stresses applied on the fiber, such as bending of the fiber. Birefringence is directly related to polarization mode dispersion, which is when two different polarizations of light in a waveguide, which normally travel at the same speed, travel at different speeds. The birefringence in an optical fiber can be measured by:

Δₙ=nₓ−n_{y}

where Δₙ is the birefringence and nₓ and n_{y} are each the effective index for a polarization state of a given mode.

The term “center point,” as used herein, is the mid-point of the diameter of a circle or the mid-point of the major and minor axes of an ellipse.

Unless otherwise specified herein, the above-referenced properties of the optical fiber disclosed herein and discussed below are modeled or measured at 1550 nm.

In the discussion below, any portion of the optical fiber that is not the core is considered part of the cladding.

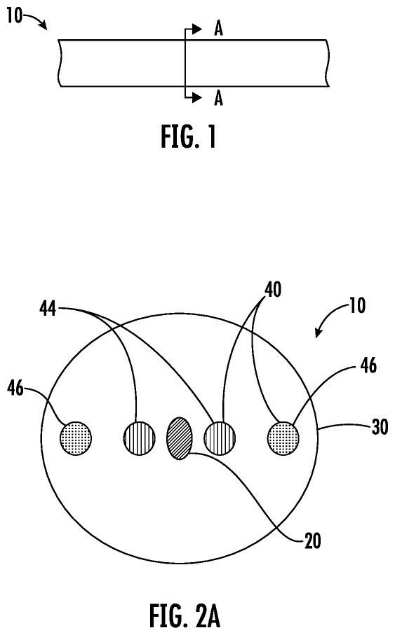

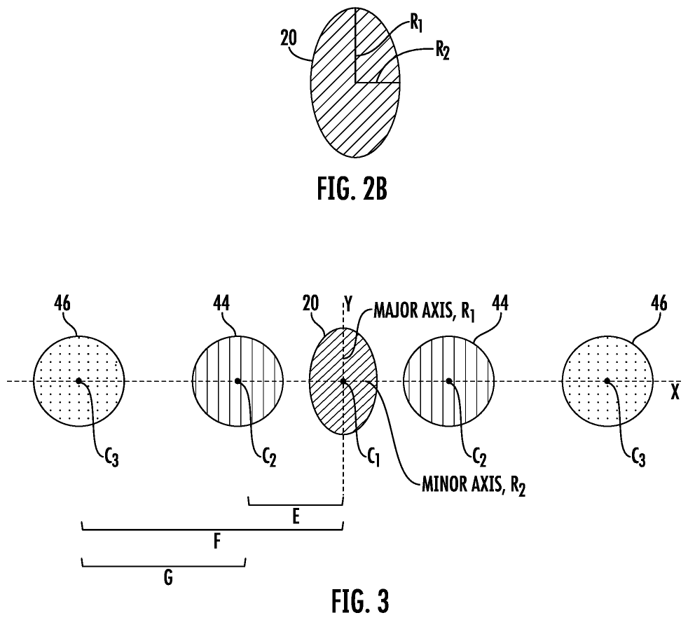

FIG. 1 is a side view of a section of a few mode optical fiber (“fiber”) 10 according to embodiments disclosed herein. FIG. 2A is a cross-sectional view of fiber 10 taken along the line A-A in FIG. 1 and illustrates a first exemplary embodiment of fiber 10. As shown in FIG. 2A, fiber 10 comprises a core 20 surrounded by a cladding 30. Core 20 may comprise pure silica glass (SiO₂) or silica glass with one or more dopants that increase the index of refraction of the glass core relative to pure, undoped silica glass. Suitable dopants for increasing the index of refraction of the core include, without limitation, GeO₂, Al₂O₃, P₂O₅, TiO₂, ZrO₂, Nb₂O₅, Ta₂O₅, and/or combinations thereof.

Core 20 may have a step index profile or a graded index profile. As discussed further below, core 20 may be circular or elliptical in cross-sectional shape.

An outer diameter of fiber 10 may be the outer diameter of cladding 30. However, in other embodiments, fiber 10 may further comprise a primary coating and/or a secondary coating, such that the outer diameter of fiber 10 is the outer diameter of the coating(s). Fiber may have an outer diameter from about 60 microns to about 260 microns, or from about 100 microns to about 200 microns, or from about 120 microns to about 180 microns, or from about 125 microns to about 165 microns. In some embodiments, a thickness of the primary coating is from about 25 microns to about 35 microns, and a thickness of the secondary coating is from about 20 microns to about 40 microns.

Fiber 10 may have a numerical aperture between about 0.15 and about 0.30, or between about 0.15 and about 0.25, or between about 0.18 and about 0.22, or between about and about 0.20.

Core 20 has an alpha value of greater than or equal to 5, or greater than or equal to 10, or greater than or equal to 15, or greater than or equal to 20, or greater than or equal to 30, or greater than or equal to 40, or greater than or equal to 40, or greater than or equal to 50, or greater than or equal to 60, or greater than or equal to 70, or greater than or equal to 80, or greater than or equal to 90, or greater than or equal to 100. Additionally or alternatively, core has an alpha value of less than or equal to 100, or less than or equal to 90, or less than or equal to 80, or less than or equal to 70, or less than or equal to 60, or less than or equal to 50, or less than or equal to 40, or less than or equal to 30, or less than or equal to 20, or less than or equal to 15.

Cladding 30 is a glass cladding that has a maximum relative refractive index Δ₂ less than a maximum relative refractive index Δ₁ of core 20 (Δ₁>Δ₂). In some embodiments, core 20 has a maximum relative refractive index Δ₁ of about 0.2% to about 1.5%, or about 0.3% to about 1.2%, or about 0.5% to about 1.0%, or about 0.6% to about 0.8%.

The maximum relative refractive index Δ₂ of cladding 30 is from about −0.20% to about 0.20%, or from about −0.15% to about 0.15%, or from about −0.10% to about 0.10%, or from about −0.05% to about 0.05%. In some embodiments, the relative refractive index Δ₂ is about 0.0%. The relative refractive index Δ₂ is preferably constant or approximately constant. Although not shown in FIG. 2A, cladding 20 may further comprises one or more depressed-index cladding regions (trench regions) with a relatively lower refractive index than the remainder of the cladding.

Core 20 supports the simultaneous propagation and transmission of multiple spatial modes at one or more wavelengths. For example, core 20 supports the simultaneous propagation and transmission of an optical signal with X number of LP modes at one or more wavelengths, wherein X is an integer greater than 1 and less than 20 (e.g., X is equal to 2, or 3, or 4, or 6, or 10, or 12, or 16, or 19). In some embodiments, core 20 supports the propagation and transmission of an optical signal with X number of LP modes at one or more wavelengths within a wavelength range from 800 nm to 1100 nm, or in the C-band wavelength range between 1530 nm and 1565 nm, or in the L-band wavelength range between 1565 nm and 1625 nm, or in the O-band wavelength range between 1260 nm and 1360 nm, such as at 1310 nm. Thus, core 20 supports the propagation and transmission of the LP01 and LP11 modes (including their degenerate subgroups). In some exemplary embodiments, core 20 supports the propagation and transmission of the LP01 mode, the LP11a mode, and the LP11b mode at one or more wavelengths, such as at wavelengths within a range of 800 nm to 1100 nm or within at least one of the C-band, L-band, or O-band wavelength ranges.

The radii of core 20 may be selected to support the different spatial modes. For example, the radii of core 20 may be selected so that the effective area A_{eff} of the LP01 mode is between about 60 micron² and about 200 micron², or between about 80 micron² and about 150 micron², or between about 90 micron² and about 125 micron².

As shown in FIG. 2A, in some embodiments, core 20 is elliptical in cross-sectional shape in order to reduce crosstalk between the different modes. The elliptical shape allows the modes to be separated when propagating within core 20 so that they are not easily coupled. However, as also discussed below, it is contemplated that core 20 is circular in cross-sectional shape in some embodiments. It is also noted that in the embodiments in which core 20 is elliptical in cross-sectional shape, cladding 30 still remains circular in cross-section.

As shown in FIG. 2B, core 20 may have a first radius R₁ along its major axis and a second radius R₂ along its minor axis (such that R₁>R₂). In some embodiments, R₁ is from about 5 microns to about 50 microns, or from about 5 microns to about 40 microns, or from about 7 microns to about 30 microns, or from about 10 microns to about 20 microns. In some embodiments, R₂ is from about 3 microns to about 30 microns, or from about 5 microns to about 20 microns, or from about 5 microns to about 10 microns. In yet some embodiments, R₁ is about 7.28 microns and R₂ is about 5.6 microns. The first radius R₁ may be 1.2×, or 1.5×, or 2×, or 3×, or 4×, or 5× larger than the second radius R₂. It is also noted that in the embodiments in which core 20 is circular in cross-sectional shape (rather than elliptical), R₁ is equal to R₂. In these embodiments, both R₁ and R₂ may be from about 3 microns to about microns, or from about 5 microns to about 40 microns, or from about 5 microns to about microns. In one exemplary embodiment, both R₁ and R₂ are 5.6 microns.

Fiber 10 further comprises one or more stress members 40 that are configured to impart tension, compression, strain, and/or stress in the drawn fiber to reduce birefringence. As discussed below, increased birefringence in the fiber can be an unintentional consequence of reducing crosstalk between the different spatial modes. Stress members 40, therefore, are added to the fibers disclosed herein to reduce any such birefringence in the fiber.

Traditional few mode fibers may experience crosstalk between the different modes as the modes propagate along the fiber. For example, traditional few mode fibers may experience crosstalk between the LP11a and LP11b modes because they have very similar effective indices and modal delays. Therefore, mode mixing and crosstalk can easily occur between these two spatial modes. By making core 20 elliptical in cross-sectional shape, crosstalk between the different modes is reduced because the modes are now spread apart by a larger distance and have a higher effective index difference. It is noted that less signal leaking occurs between modes with different effective indices than between modes with similar effective indices.

However, increasing the effective index difference of the modes propagating within the fiber can also increase the birefringence of the fiber, which results in reduced transmission quality of the optical signal. Birefringence occurs in optical fibers when the optical signal is split into two different paths. This phenomenon occurs because the optical fiber has different effective indices, which causes different indices of refraction within the fiber. Therefore, the optical signal is refracted differently by each effective index. Such results in diminished transmission of the optical signal as it propagates along the fiber. As discussed above, the different effective indices in the fiber can result from asymmetries in the fiber design or from mechanical stress (e.g., bending of the fiber). Additionally, making a core elliptical (as compared to circular) increases the effective index difference of the modes, which in turn increases the birefringence of the fiber.

More specifically, by making an optical fiber core elliptical in shape, such creates both geometrical anisotropy and asymmetrical stress in the core. These factors cause the spatial mode subgroups to be polarized along the major or minor axis of the elliptical core as they propagate along the core, causing a larger effective index difference of the spatial mode subgroups (and, thus, a larger birefringence). Stated another way, one of the major and minor axes will become a fast propagating axis while the other becomes a slow propagating axis. A spatial mode traveling along the fast propagating axis will propagate faster than another mode traveling along the slow propagating axis, thus resulting in the increased birefringence.

Stress members 40, as disclosed herein, reduce any such birefringence in the fiber. More specifically, stress members 40 reduce the effective index difference between the different modes propagating in optical fiber 10. As discussed further below, stress members impart anisotropic, thermal, and/or mechanical stress on fiber 10 that counteracts the geometrical anisotropy and asymmetrical stress imparted by, for example, an elliptical shaped core, thus reducing the birefringence of the core.

Stress members 40 may comprise at least one dopant that increases the coefficient of thermal expansion (CTE) and/or decreases the viscosity of the member. In some embodiments, the dopant comprises at least one of fluorine, chlorine, germanium, phosphorus, and boron, or an oxide thereof. For example, the dopant may comprise at least one of GeO₂, P₂O₃, and B₂O₃. Each stress member 40 may comprise about 0.1 mole % or more of the dopant, or about 0.2 mole % or more of the dopant, or about 0.3 mole % or more of the dopant, or about 1.0 mole % or more of the dopant, or about 1.2 mole % or more of the dopant, or about 1.5 mole % or more of the dopant, or about 4.0 mole % or more of the dopant, or about 5.0 mole % or more of the dopant, or about 8.0 mole % or more of the dopant, or about 10 mole % or more of the dopant, or about 15 mole % or more of the dopant, or about 20 mole % or more of the dopant, or about 25 mole % or more of the dopant. In some embodiments, at least one stress member 40 comprises about 0.5 mole % to about 4 mole % of fluorine, or about 1 mole % to about 3 mole % of fluorine, or about 1.2 mole % of fluorine, or about 1.5 mole % of fluorine. Additionally or alternatively, in some embodiments, at least one stress member 40 comprises about 3 mole % to about 20 mole % of B₂O₃, or about 4 mole % to about 10 mole % of B₂O₃, or about 5 mole % to about 8 mole % of B₂O₃, or about 4.2 mole % of B₂O₃, or about 5.6 mole % of B₂O₃, or about 8.3 mole % of B₂O₃.

Stress members 40 may be rods that extend for a length of fiber 10 and that are substantially parallel to core 20. In some embodiments, stress members 40 extend the entire length of fiber 10. However, it is also contemplated that stress members 40 only extend for a portion of the entire length of fiber 10. Thus, in some embodiments, a length of each stress member 40 is less than a length of core 20.

In the embodiment of FIG. 2A, stress members 40 comprise first stress members 44 and second stress members 46. In this embodiment, first stress members 44 comprise fluorine and second stress members comprise B₂O₃. First stress members 44 impart stress on fiber 10 by inducing asymmetry in the fiber structure. Second stress members 46 impart stress on fiber 10 by inducing anisotropy in the material property of the fiber. The stress induced by first stress member 44 and/or by second stress member 46 counteracts and cancels out the stress induced by the difference in effective index of the core. Therefore, first stress members 44 and/or second stress members 46 lower the birefringence of the optical fiber despite having a high difference in effective index. In some embodiments, first stress members 44 reduce the LP11a birefringence and second stress members 46 reduce the LP01 and LP11b birefringence.

Stress members 40 may each have a maximum relative refractive index Δ₃ that is less than the maximum relative refractive index Δ₁ of core 20 (Δ₁>Δ₃). In some embodiments, stress members 40 may have a maximum relative refractive index Δ₃ of about −0.5% to about 0.5%, or about −0.3% to about 0.3%, or about −0.25% to about 0.25%, or about −0.15% to about 0.15%, or about −0.10% to about 0.10%, or about −0.05% to about 0.05%, or about −0.02% to about 0.02%, or about 0.0%. In some embodiments, the maximum relative refractive index of first stress members 44 is different from that of second stress members 46. For example, the maximum relative refractive index of first stress members 44 may be greater than that of second stress members 46. In some embodiments, first stress members 44 have a maximum relative refractive index of −0.2% and second stress members 46 have a maximum relative refractive index of −0.3%.

In some embodiments, such as shown in FIG. 2A, stress members 40 are each circular in cross-sectional shape. However, it is also contemplated that one or more stress members may comprise other cross-sectional shapes such as elliptical. Additionally, it is also contemplated that one or more stress members 40 may be larger in diameter than one or more other stress members 40. For example, in some embodiments, first stress members 44 may each be larger than second stress members 46.

FIG. 3 shows an enlarged view of stress members 40 and core 20 of FIG. 2A. As shown in FIG. 3, core 20 may be positioned such that its major axis is disposed along the Y-axis and its minor axis is disposed along the X-axis. Furthermore, stress members 40 are also disposed along the same, common axis so that a plane that extends along the minor axis of core 20 (for example, a plane that runs along the X-axis) intersects stress members 40. More specifically, the plane that extends along the minor axis of core 20 intersects each and every stress member 40 in fiber 10. Furthermore, a plane that extends along the major axis of core (for example, a plane that runs along the Y-axis) does not interest any of the stress members 40. By positioning stress member 40 along the same plane as the minor axis of core 20, the inventors found that such helps to reduce birefringence in fiber 10 by counteracting the difference in effective index in the fiber. In some embodiments, such as shown in FIG. 3, a center point of core 20 (C₁) is disposed along the same plane as a center point of first stress members 44 (C₂) and as a center point of second stress members 46 (C₃).

As also shown in FIG. 3, center point C₁ of core 20 may be spaced from center point C₂ of first stress member 44 by a distance E of about 5 micros to about 25 microns, or about 7 microns to about 22 microns, or about 10 microns to about 20 microns, or about 12 microns to about 17 microns, or about 15 microns to about 20 microns. Furthermore, center point C₁ of core 20 may be spaced from center point C₃ of second stress member 46 by a distance F of about 20 microns to about 60 microns, or about 25 microns to about 55 microns, or about 30 microns to about 50 microns, or about 35 microns to about 45 microns, or about 40 microns to about 45 microns. Therefore, distance F is greater than distance E. Furthermore, center point C₂ of first stress member 44 may be spaced from center point C₃ of second stress member 46 by a distance G of about 15 microns to about 40 microns, or from about 20 microns to about 35 microns, or from about 25 microns to about 30 microns. In some embodiments, distance E is less than distance G and distance G is less than distance F. However, as noted above, the fibers disclosed herein may comprise only first stress member 44 or second stress member 46, in which case, the fibers will not encompass all of distances E, F, and G.

First stress members 44 may have a radius in a range from about 2 microns to about microns, or from about 4 microns to about 18 microns, or from about 6 microns to about 16 microns, or from about 8 microns to about 14 microns, or from about 8 microns to about 12 microns, or from about 8 microns to about 10 microns. Second stress members 46 may have a radius in a range from 1 micron to about 12 microns, or from about 2 microns to about microns, or from about 3 microns to about 10 microns, or from about 4 microns to about 8 microns, or from about 5 microns to about 7 microns, or from about 6 microns to about 8 microns. In some embodiments, first stress members 44 have a larger radius than second stress members 46. For example, in some exemplary embodiments, first stress members 44 have a radius of 8 microns and second stress members 46 have a radius of 6 microns. Furthermore, first stress members 44 may have a radius larger than both the first and second radius R₁, R₂ of core 20. Second stress members 46 may have a radius larger than the first radius R₁ of core 20 but smaller than the second radius R₂ of core 20.

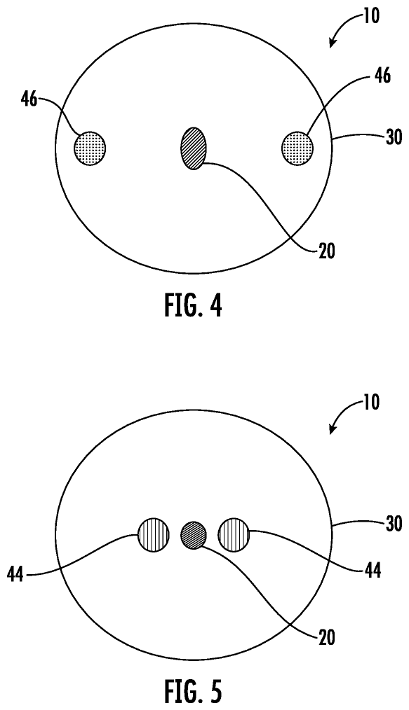

FIG. 4 shows another embodiment of fiber 10 in which the fiber includes second stress members 46 but not first stress members 44. In one exemplary embodiment, fiber 10 includes second stress members 46 comprised of B₂O₃ but does not include first stress members 44. In the embodiment of FIG. 4, the center point C₁ of core 20 may be spaced distance F from the center point C₃ of second stress members 46, as discussed above with reference to FIG. 3.

In the embodiment of FIG. 4, core 20 is elliptical in cross-sectional shape. However, as discussed above, the embodiments disclosed herein also contemplate using a circular core rather than the elliptical core depicted in FIGS. 2A-4. Therefore, for example, in the embodiments of FIGS. 2A-4, core 20 may have a circular cross-sectional profile rather than an elliptical cross-sectional profile.

FIG. 5 depicts another exemplary embodiment in which core 20 is circular in cross-sectional shape and in which fiber 10 includes first stress members 44 but does not include second stress members 46. In one exemplary embodiment, fiber 10 includes first stress members 44 comprised of fluorine but does not include second stress members 46. In the embodiment of FIG. 5, the center point C₁ of core 20 may be spaced distance E from the center point C₂ of first stress members 44, as discussed above with reference to FIG. 3.

Due to the incorporation of stress members 40 and their specific positioning relative to core 20, each mode propagating through optical fiber 10 may have a birefringence of about 6.0×10⁻⁶ or less, or about 5.8×10⁻⁶ or less, or about 5.7×10⁻⁷ or less, or about 5.6×10⁻⁶ or less, or about 5.5×10⁻⁶ or less, or about 5.4×10⁻⁶ or less, or about 5.2×10⁻⁶ or less, or about 5.0×10⁻⁶ or less, or about 4.8×10⁻⁶ or less, or about 4.6×10⁻⁶ or less, or about 4.5×10⁻⁶ or less, or about 4.2×10⁻⁶ or less, or about 4.0×10⁻⁶ or less, or about 3.8×10⁻⁶ or less, or about 3.6×10⁻⁶ or less, or about 3.5×10⁻⁶ or less, or about 3.2×10⁻⁶ or less, or about 3.0×10⁻⁶ or less, or about 2.8×10⁻⁶ or less, or about 2.6×10⁻⁶ or less, or about 2.5×10⁻⁶ or less, or about 2.4×10⁻⁶ at one or more wavelengths. In some embodiments, each mode propagating through optical fiber 10 may have the above-disclosed birefringence values at one or more wavelengths within a range of 800 nm to 1100 nm or within at least one of the C-band, L-band, or O-band wavelength ranges (such as at 1310 nm).

Furthermore, at least one mode propagating through optical fiber may have a birefringence of about 2.0×10⁻⁶ or less, or about 1.5×10⁻⁶ or less, or about 1.0×10⁻⁶ or less, or about 0.9×10⁻⁶ or less, or about 0.8×10⁻⁶ or less, or about 0.7×10⁻⁶ or less, or about 0.6×10⁻⁶ or less, or about 0.5×10⁻⁶ or less, or about 0.4×10⁻⁶ or less. In some embodiments, the at least one mode propagating through optical fiber 10 may have the above-disclosed birefringence values at one or more wavelengths within a range of 800 nm to 1100 nm or within at least one of the C-band, L-band, or O-band wavelength ranges (such as at 1310 nm).

Additionally, optical fiber 10 may have an effective index difference between the different modes propagating through the fiber of about 3.0×10⁻⁵ or greater, or about 3.2×10⁻⁵ or greater, or about 3.4×10⁻⁵ or greater, or about 3.6×10⁻⁵ or greater, or about 3.8×10⁻⁵ or greater, or about 4.0×10⁻⁵ or greater, or about 4.5×10⁻⁵ or greater, or about 5.0×10⁻⁵ or greater, or about 5.5×10⁻⁵ or greater, or about 6.0×10⁻⁵ or greater, or about 6.5×10⁻⁵ or greater, or about 7.0×10⁻⁵ or greater, or about 7.5×10⁻⁵ or greater, or about 8.0×10⁻⁵ or greater, or about 8.5×10⁻⁵ or greater, or about 9.0×10⁻⁵ or greater, or about 9.5×10⁻⁵ or greater, or about 1.0×10⁻⁴ or greater, or about 2.0×10⁻⁴ or greater, or about 2.5×10⁻⁴ or greater, or about 3.0×10⁻⁴ or greater, or about 3.2×10⁻⁴ or greater, or about 3.4×10⁻⁴ or greater, or about 3.5×10⁻⁴ or greater, or about 3.6×10⁻⁴ or greater, or about 3.8×10⁻⁴ or greater, or about 4.0×10⁻⁴ or greater, or about 4.2×10⁻⁴ or greater, or about 4.4×10⁻⁴ or greater, or about 4.6×10⁻⁴ or greater, or about 4.8×10⁻⁴ or greater, or about 5.0×10⁻⁴ or greater, or about 6.0×10⁻⁴ or greater, or about 7.0×10⁻⁴ or greater. In some embodiments, the above-disclosed effective index difference is with regard to the LP11a and LP11b modes propagating within fiber 10. In some embodiments, the above-disclosed effective index difference values are at one or more wavelengths within a range of 800 nm to 1100 nm or within at least one of the C-band, L-band, or O-band wavelength (such as at 1310 nm).

Furthermore, optical fiber 10 has the disclosed birefringence and effective index difference values over a transmission length of about 300 m or greater, or about 500 m or greater, or about 1 km or greater, or about 5 km or greater.

Tables 1-4 below provide exemplary examples of the fibers according to the embodiments disclosed herein along with comparative examples. As shown in these tables, the exemplary examples have a lower birefringence compared to the comparative examples while still maintaining a high effective index difference. In the examples of Tables 1-4, for the exemplary examples, the first stress members are comprised of fluorine and the second stress members are comprised of B₂O₃. In contrast, the comparative examples do not comprise any stress members.

TABLE 1

| | Comparative | Exemplary | Exemplary |
|---|---|---|---|
| | Example 1 | Example 2 | Example 3 |
| Fiber Radius (microns) | 62.5 | 62.5 | 62.5 |
| Core Major Axis | 7.28 | 7.28 | 7.28 |
| Radius (microns) | | | |
| Core Minor Axis | 5.6 | 5.6 | 5.6 |
| Radius (microns) | | | |
| First Stress Member | N/A | N/A | 8 |
| Radius (microns) | | | |
| Fluorine Concentration | N/A | N/A | 1.2 |
| in First Stress | | | |
| Member (mole %) | | | |
| Second Stress Member | N/A | 6 | 6 |
| Radius (microns) | | | |
| B₂O₃ Concentration in | N/A | 8.33 | 8.33 |
| Second Stress | | | |
| Member (mole %) | | | |
| First Stress Member | N/A | N/A | 15 |
| Center Point to Core | | | |
| Center Point (microns) | | | |
| Second Stress Member | N/A | 40 | 40 |
| Center Point to Core | | | |
| Center Point (microns) | | | |
| Core Maximum Relative | 0.5 | 0.5 | 0.5 |
| Refractive Index (%) | | | |
| Core alpha | 100 | 100 | 100 |
| Cladding Maximum | 0 | 0 | 0 |
| Relative Refractive | | | |
| Index (%) | | | |
| First Stress Member | N/A | N/A | −0.2 |
| Maximum Relative | | | |
| Refractive Index (%) | | | |
| Second Stress Member | N/A | −0.3 | −0.3 |
| Maximum Relative | | | |
| Refractive Index (%) | | | |
| LP01 Mode | 1.51 × 10⁻⁵ | 6.04 × 10⁻⁷ | 7.87 × 10⁻⁷ |
| Birefringence at 1310 nm | | | |
| LP11a Mode | 1.15 × 10⁻⁵ | 3.21 × 10⁻⁶ | 1.63 × 10⁻⁶ |
| Birefringence at 1310 nm | | | |
| LP11b Mode | 1.57 × 10⁻⁵ | 1.63 × 10⁻⁶ | 1.68 × 10⁻⁶ |
| Birefringence at 1310 nm | | | |
| LP11a/LP11b Mode | 6.81 × 10⁻⁴ | 6.81 × 10⁻⁴ | 7.15 × 10⁻⁴ |
| Effective Index | | | |
| Difference | | | |

In Table 1 above, Exemplary Example 2 comprises second stress members of B₂O₃ but does not comprise a first stress member. Exemplary Example 3 comprises both first and second stress members. In contrast, Comparative Example 1 does not comprise either first or second stress members. Both Exemplary Examples 2 and 3 have lower birefringence for each of modes LP01, LP11a, and LP11b as compared to Comparative Example 1, while still maintaining a high effective index difference.

TABLE 2

| | Comparative | Exemplary | Exemplary |
|---|---|---|---|
| | Example 4 | Example 5 | Example 6 |
| Fiber Radius (microns) | 62.5 | 62.5 | 62.5 |
| Core Major Axis | 6.16 | 7.28 | 6.16 |
| Radius (microns) | | | |
| Core Minor Axis | 5.6 | 5.6 | 5.6 |
| Radius (microns) | | | |
| First Stress Member | N/A | 8 | N/A |
| Radius (microns) | | | |
| Fluorine Concentration | N/A | 1.2 | N/A |
| in First Stress | | | |
| Member (mole %) | | | |
| Second Stress Member | N/A | 6 | 6 |
| Radius (microns) | | | |
| B₂O₃ Concentration in | N/A | 8.33 | 4.17 |
| Second Stress | | | |
| Member (mole %) | | | |
| First Stress Member | N/A | 15 | N/A |
| Center Point to Core | | | |
| Center Point (microns) | | | |
| Second Stress Member | N/A | 40 | 40 |
| Center Point to Core | | | |
| Center Point (microns) | | | |
| Core Maximum Relative | 0.5 | 0.5 | 0.5 |
| Refractive Index (%) | | | |
| Core alpha | 100 | 15 | 100 |
| Cladding Maximum | 0 | 0 | 0 |
| Relative Refractive | | | |
| Index (%) | | | |
| First Stress Member | N/A | −0.2 | N/A |
| Maximum Relative | | | |
| Refractive Index (%) | | | |
| Second Stress Member | N/A | −0.3 | −0.15 |
| Maximum Relative | | | |
| Refractive Index (%) | | | |
| LP01 Mode | 5.49 × 10⁻⁶ | 5.91 × 10⁻⁷ | 1.76 × 10⁻⁶ |
| Birefringence at 1310 nm | | | |
| LP11a Mode | 1.74 × 10⁻⁶ | 2.7 × 10⁻⁶ | 5.63 × 10⁻⁶ |
| Birefringence at 1310 nm | | | |
| LP11b Mode | 7.57 × 10⁻⁶ | 3.09 × 10⁻⁶ | 4.62 × 10⁻⁷ |
| Birefringence at 1310 nm | | | |
| LP11a/LP11b Effective | 2.71 × 10⁻⁴ | 7.69 × 10⁻⁴ | 2.71 × 10⁻⁴ |
| Index Difference | | | |

In Table 2 above, Exemplary Example 5 comprises first stress members of fluorine and second stress members of B₂O₃. Exemplary Example 6 comprises second stress members but not a first stress member. In contrast, Comparative Example 4 does not comprise either first or second stress members. Both Exemplary Examples 5 and 6 have overall lower birefringence for the LP01, LP11a, and LP11b modes as compared to Comparative Example 4, while still maintaining a high effective index difference.

TABLE 3

| | Comparative | Exemplary | Exemplary | Exemplary |
|---|---|---|---|---|
| | Example 7 | Example 8 | Example 9 | Example 10 |
| Fiber Radius (microns) | 62.5 | 62.5 | 62.5 | 62.5 |
| Core Major Axis | 5.6 | 5.6 | 5.6 | 5.6 |
| Radius (microns) | | | | |
| Core Minor Axis | 6.72 | 6.16 | 6.72 | 6.72 |
| Radius (microns) | | | | |
| First Stress Member | N/A | 8 | N/A | 8 |
| Radius (microns) | | | | |
| Fluorine Concentration | N/A | 1.5 | N/A | 1.2 |
| in First Stress | | | | |
| Member (mole %) | | | | |
| Second Stress Member | N/A | 6 | 6 | 6 |
| Radius (microns) | | | | |
| B₂O₃ Concentration in | N/A | 4.17 | 5.55 | 5.55 |
| Second Stress | | | | |
| Member (mole %) | | | | |
| First Stress Member | N/A | 15 | N/A | 15 |
| Center Point to Core | | | | |
| Center Point (microns) | | | | |
| Second Stress Member | N/A | 40 | 40 | 40 |
| Center Point to Core | | | | |
| Center Point (microns) | | | | |
| Core Maximum Relative | 0.5 | 0.5 | 0.5 | 0.5 |
| Refractive Index (%) | | | | |
| Core alpha | 15 | 100 | 15 | 15 |
| Clad Maximum | 0 | 0 | 0 | 0 |
| Relative Refractive | | | | |
| Index (%) | | | | |
| First Stress Member | N/A | −0.25 | N/A | −0.2 |
| Relative Refractive | | | | |
| Index (%) | | | | |
| Second Stress Member | N/A | −0.15 | −0.2 | −0.2 |
| Relative Refractive | | | | |
| Index (%) | | | | |
| LP01 Mode | 1.04 × 10⁻⁵ | 1.55 × 10⁻⁶ | 7.70 × 10⁻⁷ | 9.30 × 10⁻⁷ |
| Birefringence at 1310 nm | | | | |
| LP11a Mode | 4.69 × 10⁻⁶ | 3.85 × 10⁻⁶ | 5.13 × 10⁻⁶ | 3.57 × 10⁻⁶ |
| Birefringence at 1310 nm | | | | |
| LP11b Mode | 1.35 × 10⁻⁵ | 5.39 × 10⁻⁷ | 4.03 × 10⁻⁶ | 4.08 × 10⁻⁶ |
| Birefringence at 1310 nm | | | | |
| LP11a/LP11b Mode | 5.31 × 10⁻⁴ | 3.13 × 10⁻⁴ | 5.31 × 10⁻⁴ | 5.65 × 10⁻⁴ |
| Effective Index | | | | |
| Difference | | | | |

In Table 3 above, both Exemplary Examples 8 and 10 comprise first stress members of fluorine and second stress members of B₂O₃. Exemplary Example 9 comprises second stress members but not a first stress member. In contrast, Comparative Example 7 does not comprise either first or second stress members. Exemplary Examples 8-10 have overall lower birefringence for the LP01, LP11a, and LP11b modes as compared to Comparative Example 7, while still maintaining a high effective index difference.

TABLE 4

| | Exemplary | Exemplary |
|---|---|---|
| | Example 11 | Example 12 |
| Fiber Radius (microns) | 62.5 | 62.5 |
| Core Major Axis Radius | 5.6 | 5.6 |
| (microns) | | |
| Core Minor Axis Radius | 5.6 | 5.6 |
| (microns) | | |
| First Stress Member | 8 | 8 |
| Radius (microns) | | |
| Fluorine Concentration | 1.2 | 1.2 |
| in First Stress | | |
| Member (mole %) | | |
| Second Stress Member | N/A | N/A |
| Radius (microns) | | |
| B₂O₃ Concentration in | N/A | N/A |
| Second Stress | | |
| Member (mole %) | | |
| First Stress Member | 15 | 15 |
| Center Point to Core | | |
| Center Point (microns) | | |
| Second Stress Member | N/A | N/A |
| Center Point to Core | | |
| Center Point (microns) | | |
| Core Maximum Relative | 0.5 | 0.5 |
| Refractive Index (%) | | |
| Core alpha | 15 | 50 |
| Clad Maximum Relative | 0 | 0 |
| Refractive Index (%) | | |
| First Stress Member | −0.2 | −0.2 |
| Relative Refractive | | |
| Index (%) | | |
| Second Stress Member | N/A | N/A |
| Relative Refractive | | |
| Index (%) | | |
| LP01 Mode | 1.60 × 10⁻⁷ | 1.84 × 10⁻⁷ |
| Birefringence at 1310 nm | | |
| LP11a Mode | 4.98 × 10⁻⁶ | 2.70 × 10⁻⁶ |
| Birefringence at 1310 nm | | |
| LP11b Mode | 5.60 × 10⁻⁶ | 3.25 × 10⁻⁶ |
| Birefringence at 1310 nm | | |
| LP11a/LP11b Mode | 3.20 × 10⁻⁵ | 3.40 × 10⁻⁵ |
| Effective Index | | |
| Difference | | |

In Table 4 above, both Exemplary Examples 11 and 12 comprise first stress members of fluorine but not a second stress member. Exemplary Examples 11 and 12 both have an overall low birefringence for the LP01, LP11a, and LP11b modes while still maintaining a high effective index difference.

As shown in Tables 1-4 above, embodiments of the present disclosure provide an optical fiber with reduced birefringence while still maintaining a high effective index difference between the propagating modes. Therefore, the transmission quality of the propagating modes is not diminished, despite the high effective index difference.

In the present disclosure, numerical modeling was used to determine the stress induced on the optical fibers. More specifically, the Finite Element Method (FEM) was used to determine the stress induced on the optical fibers. For such numerical modeling, it was assumed that the fiber was cooled down from a high temperature of about 1000° C. to about 20° C. during the fiber making process. The difference in thermal expansion among different parts of the fiber (due to the different material properties of these parts) causes stress in the fiber as it is cooled, especially in the core of the fiber. Such stress induces anisotropic refractive index changes and results in birefringence in the fiber.

The overall effective index was then modeled as an optical waveguide, and the effective index of each fiber was calculated for both polarizations of each mode (e.g., for both polarizations of the LP01, LP11a, and LP11b modes). Furthermore, for the numerical modeling, it was assumed that the fiber comprised a GeO₂ doped core, a fluorine doped stress member, and a B₂O₃ stress member. The coefficient of thermal expansion (CTE) was then obtained for the GeO₂ doped silica core and the B₂O₃ doped silica stress member. The differential CTE per unit molar percent was measured to be 6.510⁻⁸/° C. for the GeO₂ doped core and 9.510⁻⁸/° C. for the B₂O₃ stress member. The relative index difference A introduced by unit molar percent is about 0.09% for the GeO₂ doped core and −0.036% for the B₂O₃ stress member as compared to pure silica. For the fluorine doped stress member, the CTE is basically independent of the amount of fluorine used and is equal to the CTE value of pure silica. The relations between the CTE and index Δ for the germanium doped core, the B₂O₃ stress member, and the fluorine doped stress member as compared to pure silica are given by:

α_{GeO2}(Δ)=5.4×10⁻⁷+7.222×10⁻⁷Δ

α_{B2O3}(Δ)=5.4×10⁻⁷−2.639×10⁻⁶Δ

α_{F}(Δ)=5.4×10⁻⁷

It is further noted that for the numerical modelling (as discussed above), the materials of the fibers had the following properties:
Young's module: 78 GPa
Poisson's Ratio: 0.186
Density: 2203 kg/m³

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A few mode optical fiber, comprising:
a core; and
a cladding surrounding the core, the cladding comprising at least one stress member,
wherein:
the core and the cladding support the propagation and transmission of at least LP01, LP11a, and LP11b modes at one or more wavelengths,
the LP01, LP11a, and LP11b modes each have a birefringence of about 5.7×10⁻⁶ or less at 1310 nm, and
an effective index difference between the LP11a and LP11b modes is about 3.0×10⁻⁵ or greater.

2. The few mode optical fiber of claim 1, wherein the stress member is comprised of B₂O₃.

3. The few mode optical fiber of claim 2, wherein the stress member comprises about 3 mole % to about 20 mole % of B₂O₃.

4. The few mode optical fiber of claim 1, wherein the stress member is comprised of fluorine.

5. The few mode optical fiber of claim 1, wherein the stress member comprises about 0.5 mole % to about 4 mole % of fluorine.

6. The few mode optical fiber of claim 1, wherein the at least one stress member comprises a first stress member and a second stress member.

7. The few mode optical fiber of claim 6, wherein the cladding is disposed between the first stress member and the second stress member.

8. The few mode optical fiber of claim 6, wherein the first stress member comprises fluorine and the second stress member comprises B₂O₃.

9. The few mode optical fiber of claim 6, wherein a first plane intersects the core, the first stress member, and the second stress member.

10. The few mode optical fiber of claim 9, wherein the core is elliptical in cross-sectional shape and the first plane extends along a minor axis of the elliptical shape of the core.

11. The few mode optical fiber of claim 9, wherein the first plane intersect a center point of the core, a center point of the first stress member, and a center point of the second stress member.

12. The few mode optical fiber of claim 11, wherein a second plane intersects the core but does not intersect the first stress member and the second stress member, the first plane being perpendicular to the second plane.

13. The few mode optical fiber of claim 6, wherein the first stress member has a radius of about 6 microns to about 16 microns.

14. The few mode optical fiber of claim 1, wherein the core is elliptical in cross-sectional shape.

15. The few mode optical fiber of claim 1, wherein the core is circular in cross-sectional shape.

16. The few mode optical fiber of claim 1, wherein the birefringence of each of the LP01, LP11a, and LP11b modes is about 5.6×10⁻⁶ or less at 1310 nm.

17. The few mode optical fiber of claim 16, wherein the birefringence of each of the LP01, LP11a, and LP11b modes is about 5.0×10⁻⁶ or less at 1310 nm.

18. The few mode optical fiber of claim 1, wherein the effective index difference between the LP11a and LP11b modes is about 3.2×10⁻⁵ or greater.

19. The few mode optical fiber of claim 18, wherein the effective index difference between the LP11a and LP11b modes is about 3.4×10⁻⁵ or greater.

20. A few mode optical fiber, comprising:
a core; and
a cladding surrounding the core, the cladding comprising at least one stress member,
wherein:
the core and the cladding support the propagation and transmission of at least LP01, LP11a, and LP11b modes at one or more wavelengths, and
at least one of the LP01, LP11a, and LP11b modes has a birefringence of 1.0×10⁻⁶ or less at 1310 nm.
